(19) United States
(12) Patent Application Publication
(10) Pub. No.: US 2025/0317863 A1
(43) Pub. Date: Oct. 9, 2025

(54) SIGNAL PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventors: Dongru LI, Dongguan (CN); Xueming PAN, Dongguan (CN)

(21) Appl. No.: 19/245,448

(22) Filed: Jun. 23, 2025

Related U.S. Application Data
(63) Continuation of application No. PCT/CN2023/139581, filed on Dec. 18, 2023.

(30) Foreign Application Priority Data
Dec. 23, 2022 (CN) 202211666502.9

(51) Int. Cl. H04W 52/02

(52) U.S. Cl. CPC H04W 52/0235; H04W 52/0212

(57) ABSTRACT

This application relates to the field of communication technologies. Disclosed are a signal processing method and apparatus, a terminal, and a network side device. The signal processing method in embodiments of this application includes: A terminal obtains beacon signal configuration information and wake-up signal configuration information that are configured in different configuration manners. The terminal monitors a beacon signal and a wake-up signal based on the beacon signal configuration information and the wake-up signal configuration information.

### CROSS-REFERENCE TO RELATED APPLICATIONS

This application is a continuation of International Patent Application No. PCT/CN2023/139581, filed on Dec. 18, 2023, which claims priority to Chinese Patent Application No. 202211666502.9, entitled “SIGNAL PROCESSING METHOD AND APPARATUS, TERMINAL, AND NETWORK SIDE DEVICE” and filed on Dec. 23, 2022, both of which are incorporated by reference in their entireties.

### TECHNICAL FIELD

This application relates to the field of mobile communication technologies, and specifically, to a signal processing method and apparatus, a terminal, and a network side device.

### BACKGROUND

Currently, a low power receiver, that is, a low power wake-up receiver (LP-WUR), or referred to as an almost zero power wake-up receiver (AZP-WUR) may be introduced into a receiving module of a terminal, to reduce reception activities of the terminal in a standby state, and actually disable a Radio Frequency (RF) module and a baseband modem (MODEM) module, so as to significantly reduce power consumption of communication reception. The almost zero power wake-up receiver does not require complex signal detection (such as amplification, filtering, and quantization) by the RF module and signal processing by the MODEM module, but only relies on passive matched filtering and signal processing with low power consumption. On a base station side, a wake-up signal (WUS) is triggered on demand, so that the almost zero power wake-up receiver can be activated to acquire an activation notification, to trigger a series of processes in the terminal, for example, enabling a radio frequency transceiver module, a baseband processing module, and the like.

In addition, the low power receiver may further receive a beacon signal to achieve time synchronization, and perform mobility measurement, channel measurement, or the like.

### SUMMARY

Embodiments of this application provide a signal processing method and apparatus, a terminal, and a network side device.

According to a first aspect, a signal processing method is provided, including:
obtaining, by a terminal, beacon signal configuration information and wake-up signal configuration information that are configured in different configuration manners; and
monitoring, by the terminal, a beacon signal and a wake-up signal based on the beacon signal configuration information and the wake-up signal configuration information.

According to a second aspect, a signal processing method is provided, including:
configuring, by a network side device, beacon signal configuration information and wake-up signal configuration information for a terminal in different configuration manners.

According to a third aspect, a signal processing apparatus is provided, including:
a first obtaining module, configured to obtain beacon signal configuration information and wake-up signal configuration information that are configured in different configuration manners; and
a monitoring module, configured to monitor a beacon signal and a wake-up signal based on the beacon signal configuration information and the wake-up signal configuration information.

According to a fourth aspect, a signal processing apparatus is provided, including:
a configuration module, configured to configure beacon signal configuration information and wake-up signal configuration information for a terminal in different configuration manners.

According to a fifth aspect, a terminal is provided, including a processor and a memory, the memory storing a program or instructions executable on the processor, the program or instructions, when executed by the processor, implementing the steps of the method according to the first aspect.

According to a sixth aspect, a network side device is provided, including a processor and a memory, the memory storing a program or instructions executable on the processor, the program or instructions, when executed by the processor, implementing the steps of the method according to the second aspect.

According to a seventh aspect, a signal processing system is provided, including a terminal and a network side device, where the terminal may be configured to perform the steps of the signal processing method according to the first aspect, and the network side device may be configured to perform the steps of the signal processing method according to the second aspect.

According to an eighth aspect, a readable storage medium is provided, the readable storage medium storing a program or instructions, the program or instructions, when executed by a processor, implementing the steps of the method according to the first aspect or the steps of the method according to the second aspect.

According to a ninth aspect, a chip is provided, including a processor and a communication interface coupled to each other, where the processor is configured to run a program or instructions to implement the method according to the first aspect or the method according to the second aspect.

According to a tenth aspect, a computer program/program product is provided, where the computer program/program product is stored in a storage medium, and the computer program/program product is executed by at least one processor to implement the steps of the method according to the first aspect or the second aspect.

According to an eleventh aspect, an embodiment of this application provides a signal processing apparatus. The apparatus is configured to perform the steps of the signal processing method according to the first aspect or the second aspect.

In the embodiments of this application, a terminal can obtain beacon signal configuration information and wake-up signal configuration information that are configured in different configuration manners, to monitor a beacon signal and a wake-up signal based on the beacon signal configuration information and the wake-up signal configuration information. It can be seen that, in the embodiments of this application, the beacon signal configuration information and the wake-up signal configuration information can be configured for the terminal in different configuration manners.

### BRIEF DESCRIPTION OF THE DRAWINGS

FIG. 1 is a block diagram of a wireless communication system to which an embodiment of this application is applicable;

FIG. 2 is a schematic diagram of an operating principle of an LP-WUR or an LP-WUS in New Radio (NR) according to an embodiment of this application;

FIG. 3 is a schematic diagram of a time domain pattern of an on-off keying signal according to an embodiment of this application;

FIG. 4 is a schematic diagram of a frame structure of a beacon signal according to an embodiment of this application;

FIG. 5 is a flowchart of a signal processing method according to an embodiment of this application;

FIG. 6 is a schematic diagram of a first time interval according to an embodiment of this application;

FIG. 7 is a schematic diagram of a periodic beacon signal according to an embodiment of this application;

FIG. 8 is a flowchart of another signal processing method according to an embodiment of this application;

FIG. 9 is a block diagram of a structure of a signal processing apparatus according to an embodiment of this application;

FIG. 10 is a block diagram of a structure of another signal processing apparatus according to an embodiment of this application;

FIG. 11 is a block diagram of a structure of a communication device according to an embodiment of this application;

FIG. 12 is a block diagram of a structure of a terminal according to an embodiment of this application;

FIG. 13 is a block diagram of a structure of a network side device according to an embodiment of this application; and

FIG. 14 is a block diagram of a structure of another network side device according to an embodiment of this application.

### DETAILED DESCRIPTION

The following clearly describes the technical solutions in the embodiments of this application with reference to the accompanying drawings in the embodiments of this application. Apparently, the described embodiments are some rather than all of the embodiments of this application. All other embodiments obtained by a person of ordinary skill in the art based on the embodiments of this application fall within the protection scope of this application.

In the specification and the claims of this application, the terms “first”, “second”, and so on are intended to distinguish similar objects but do not necessarily indicate a specific order or sequence. It is to be understood that the term used in such a way is interchangeable in proper circumstances, so that the embodiments of this application can be implemented in other sequences than the sequence illustrated or described herein. In addition, the objects distinguished by “first”, “second”, and the like are usually of one type, and a quantity of objects is not limited, for example, there may be one or more first objects. In addition, “and/or” used in the specification and the claims represents at least one of the connected objects, and a character “/” in this specification generally indicates an “or” relationship between the associated objects.

It is to be noted that, the technologies described in the embodiments of this application are not limited to a long term evolution (LTE)/LTE-Advanced (LTE-A) system, or may be applied to other wireless communication systems such as code division multiple access (CDMA), time division multiple access (TDMA), frequency division multiple access (FDMA), orthogonal frequency division multiple access (OFDMA), single-carrier frequency-division multiple access (SC-FDMA), and another system. In the embodiments of this application, the terms “system” and “network” are usually interchangeably used, and the technology described herein can be applied to the systems and wireless technologies mentioned above, and can also be applied to other systems and wireless technologies. Although the technologies are also applicable to applications other than NR system applications, for example, a 6th Generation (6G) communication system, an NR system is exemplarily described in the following descriptions, and the term “NR” is used in most of the following descriptions.

However, currently, configuration manners of the beacon signal and the wake-up signal have poor flexibility, the terminal may have inconsistent understanding with a network side device in different configuration manners, resulting in a problem such as degraded communication reliability.

Embodiments of this application provide a signal processing method and apparatus, a terminal, and a network side device, to flexibly configure a beacon signal and a wake-up signal. In this way, some information in the beacon signal configuration information and some information in the wake-up signal configuration information can be configured in different manners, so that flexibility of the beacon signal configuration information and wake-up signal configuration information is improved, and when different terminals need to be configured with some different information, some different information can be configured for different terminals. However, when a plurality of terminals need to be configured with same information, configuration may be performed in a unified manner, to save signaling resources and reduce a probability that the terminal has inconsistent understanding with a network side device in different configuration manners, so as to improve communication reliability.

FIG. 1 is a block diagram of a wireless communication system to which an embodiment of this application is applicable. The communication system includes a terminal 11 and a network side device 12. The terminal 11 may be a terminal side device such as a mobile phone, a tablet personal computer, a laptop computer or notebook computer, a personal digital assistant (PDA), a palmtop computer, a notebook, an ultra-mobile personal computer (UMPC), a mobile Internet device (MID), an augmented reality (AR)/virtual reality (VR) device, a robot, a wearable device, a vehicle user equipment (VUE), a pedestrian user equipment (PUE), a smart household (which is a household device having a wireless communication function, for example, a refrigerator, a television, a washing machine, or furniture), a game console, a personal computer (PC), a teller machine, self-service machine, or the like. The wearable device includes: a smart watch, a smart bracelet, a smart headset, smart glasses, smart jewelry (a smart bangle, a smart chain bracelet, a smart ring, a smart necklace, a smart ankle bangle, a smart anklet, or the like), a smart wristband, smart clothing, and the like. It is to be noted that, a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another suitable term in the field. The base station is not limited to a specific technical term as long as the same technical effect is achieved. It is to be noted that, in the embodiments of this application, the base station in the NR system is only used as an example for description, but a specific type of the base station is not limited.

The core network device may include, but not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), centralized network configuration (CNC), a network repository function (NRF), a network exposure function (NEF), a local NEF (or L-NEF), a binding support function (BSF), an application function (AF), or the like. It is to be noted that, in the embodiments of this application, the core network device in the NR system is only used as an example for description, but a specific type of the core network device is not limited.

For ease of understanding of the signal processing method in the embodiments of this application, related technologies are first described below.

### 1. Low Power Receiver

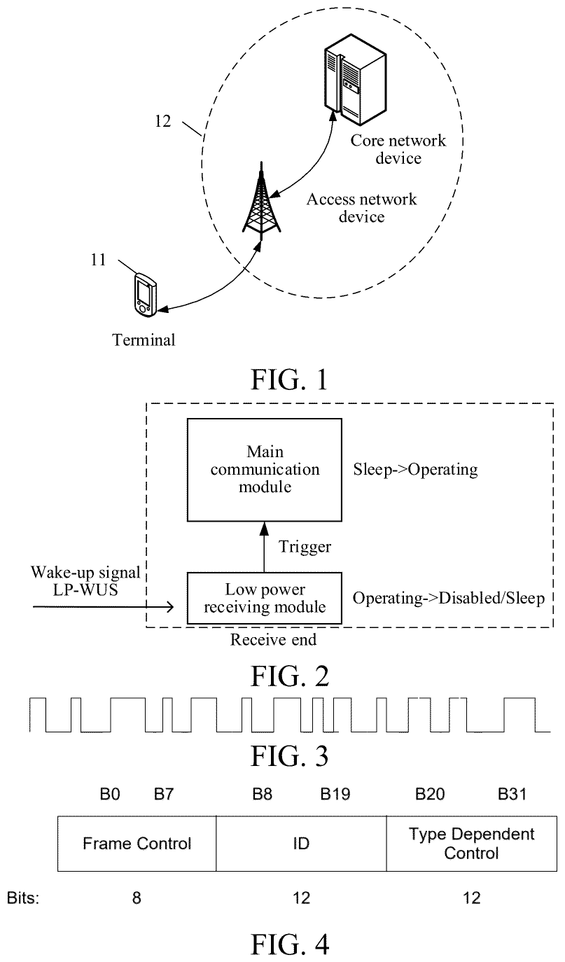

The low power receiver is a low power wake-up receiver (LP-WUR), or referred to as an almost zero power wake-up receiver (AZP-WUR). A basic operating principle of the LP-WUR is as follows: A receive end includes a first module and a second module. Specifically, as shown in FIG. 2, the first module is a main communication module configured to send and receive mobile communication data, and the second module is a low power receiving module (also referred to as a low power wake-up receiving module) configured to receive a wake-up signal. A terminal in an energy saving state enables the low power receiving module to monitor an LP-WUS, and disables the main communication module. When downlink data arrives, a network sends a wake-up signal to the terminal. After monitoring the wake-up signal through the low power receiving module, the terminal performs a series of determining and triggers the main communication module to switch from a disabled state to an enabled state. In this case, the low power receiving module enters a disabled state from an operating state. The low power wake-up receiving module may be continuously or intermittently enabled. When enabled, the low power wake-up receiving module may receive a low power wake-up signal.

### 2. Low Power Wake-Up Signal

An almost zero power wake-up receiver may be introduced into a receiving module of a terminal, to reduce reception activities of the terminal in a standby state, and actually disable a Radio Frequency (RF) module and a baseband modem (MODEM) module, so as to significantly reduce power consumption of communication reception. The almost zero power wake-up receiver does not require complex signal detection (such as amplification, filtering, and quantization) by the RF module and signal processing by the MODEM module, but only relies on passive matched filtering and signal processing with low power consumption.

On a base station side, a wake-up signal is triggered on demand, so that the almost zero power wake-up receiver can be activated to acquire an activation notification, to trigger a series of processes in the terminal, for example, enabling a radio frequency transceiver module, a baseband processing module, and the like.

Such wake-up signals are usually some simple on-off keying signals. A time domain pattern of the on-off keying signals is shown in FIG. 3. In this way, the receiver can acquire a wake-up notification through simple energy detection and subsequent possible processes such as sequence detection and recognition. In addition, when the terminal enables the low power wake-up receiver to receive the wake-up signal, a main receiver module may maintain operation at low power, and receive the wake-up signal, to achieve power saving.

### 3. Beacon Signal

The beacon signal is a signal that is periodically sent to transfer time information. A receive end may receive a beacon signal to obtain time synchronization information. In some embodiments, the receive end may further receive a beacon signal to perform mobility measurement, channel measurement, or the like. Both the beacon signal and an LP-WUS are received by a low power receiver. In an embodiment, the beacon signal may be considered as a downlink synchronization signal for receiving the LP-WUS. In another embodiment, the beacon signal may also be used for terminal mobility measurement, for example, a function such as cell selection or cell reselection. In addition, optionally, there may be an association relationship between a beacon signal sequence and an LP-WUS sequence. For example, the beacon signal sequence is a part of the LP-WUS sequence.

In a related protocol, transmission of a beacon signal is performed by using a specific medium access control (MAC) frame (frame), and a structure of the beacon signal is shown in FIG. 4. Type dependent control (Type dependent control) of a beacon medium access control frame (WUR beacon MAC frame) of a wake-up signal carries information about the 5th bit to the 16th bit in 64 bits of a clock of a timing master clock (AP). After a user receives a corresponding information bit, a local TOF clock of the user is updated according to a time update criterion defined by 802.11ba, to achieve AP synchronization.

A sending period and an offset of a sending start position of a WUR beacon are indicated by an operation element sent by the AP. The period is a minimum quantity of TSF time units between two times of beacon sending, and the start position is a quantity of TSF time units offset relative to TSFO. When Carrier Sense Multiple Access (CSMA) deferral occurs, the WUR beacon is sent in a delayed manner in a current period, but is still sent in a subsequent period at a location determined based on the sending period and the sending start position of the WUR beacon.

With reference to the accompanying drawings, the signal processing method provided in the embodiments of this application is described in detail below by using some embodiments and application scenarios thereof.

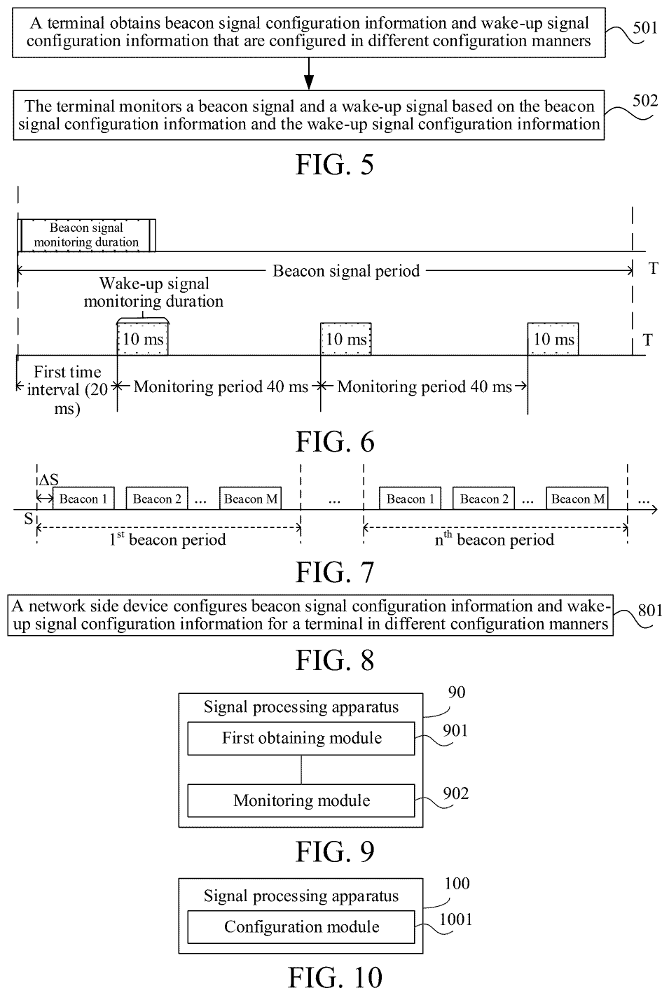

According to a first aspect, FIG. 5 is a flowchart of a signal processing method according to an embodiment of this application. The method may include step 501 and step 502 in the following:

Step 501: A terminal obtains beacon signal configuration information and wake-up signal configuration information that are configured in different configuration manners.

In this embodiment of this application, the beacon signal configuration information and the wake-up signal configuration information are configured in different configuration manners. The beacon signal configuration information includes a plurality of pieces of different configuration information, and the wake-up signal configuration information includes a plurality of pieces of different configuration information. Different configuration information in the beacon signal configuration information and different configuration information in the wake-up signal configuration information may be flexibly combined, and obtained combinations may be configured in different configuration manners.

It may be understood that, different configuration manners are not limited to the beacon signal configuration information and the wake-up signal configuration information. Different configuration manners may be used for the configuration information included in the beacon signal configuration information. Similarly, different configuration manners are applicable to the configuration information included in the wake-up signal configuration information.

The beacon signal configuration information may include at least one of a beacon signal period, a reference beacon signal period, a start position of the beacon signal period, an end position of the beacon signal period, a start offset of beacon signal monitoring, a beacon signal sequence, a beacon signal monitoring occasion, or beacon signal monitoring duration.

Optionally, information about the reference beacon signal period includes information about a length of the reference beacon signal period and/or information about a serial number of the reference beacon signal period.

It may be understood that the beacon signal monitoring duration may also be referred to as a beacon signal monitoring time window.

In addition, the wake-up signal configuration information may include at least one of a wake-up signal period, wake-up signal monitoring duration, a wake-up signal sequence, a wake-up signal monitoring occasion, wake-up signal monitoring offset information, or a wake-up signal monitoring offset list.

It can be learned that, in this embodiment of this application, several of “the beacon signal period, the reference beacon signal period, the start position of the beacon signal period, the end position of the beacon signal period, the start offset of beacon signal monitoring, the beacon signal sequence, the beacon signal monitoring occasion, the beacon signal monitoring duration, the wake-up signal period, the wake-up signal monitoring duration, the wake-up signal sequence, the wake-up signal monitoring occasion, the wake-up signal monitoring offset information, and the wake-up signal monitoring offset list” may be flexibly combined, and obtained combinations may be configured in different configuration manners.

Step 502: The terminal monitors a beacon signal and a wake-up signal based on the beacon signal configuration information and the wake-up signal configuration information.

In this embodiment of this application, after obtaining the beacon signal configuration information and the wake-up signal configuration information, the terminal monitors the beacon signal and the wake-up signal based on the obtained beacon signal configuration information and the obtained wake-up signal configuration information.

As can be learned from step 501 and step 502, in the embodiments of this application, a terminal can obtain beacon signal configuration information and wake-up signal configuration information that are configured in different configuration manners, to monitor a beacon signal and a wake-up signal based on the beacon signal configuration information and the wake-up signal configuration information. It can be seen that, in the embodiments of this application, the beacon signal configuration information and the wake-up signal configuration information can be configured for the terminal in different configuration manners. In this way, some information in the beacon signal configuration information and some information in the wake-up signal configuration information can be configured in different manners, so that flexibility of the beacon signal configuration information and wake-up signal configuration information is improved, and when different terminals need to be configured with some different information, some different information can be configured for different terminals. However, when a plurality of terminals need to be configured with same information, configuration may be performed in a unified manner, to save signaling resources and reduce a probability that the terminal has inconsistent understanding with a network side device in different configuration manners, so as to improve communication reliability.

Optionally, “a terminal obtains beacon signal configuration information and wake-up signal configuration information that are configured in different configuration manners” in step 501 includes:
obtaining, by the terminal, first information configured by using cell common signaling or specified in a specification, where the first information includes at least one of first beacon signal configuration information and first wake-up signal configuration information; and
obtaining, by the terminal, second information configured by using UE specific signaling, where the second information includes at least one of second beacon signal configuration information or second wake-up signal configuration information.

In other words, there may be two configuration manners for the beacon signal configuration information and the wake-up signal configuration information. Manner 1: The information is configured by using cell common signaling of an access network or specified in a specification. Manner 2: The information is configured by using UE specific signaling of a core network or an access network.

In Manner 1, configurations of the beacon signal configuration and the wake-up signal configuration of a same cell or a cell in a same single frequency network (SFN) are the same. This undoubtedly reduces overheads of many network signaling resources. However, configuration flexibility of such a cell-level configuration granularity (granularity) or an SFN-level configuration granularity is limited. In particular, for a configuration of the wake-up signal, some parameters, for example, wake-up signal monitoring offset information, in the configuration do not need to be configured to be completely the same for different terminals.

In Manner 2, different parameters and values may be configured for different terminals. However, because a configuration granularity is for each terminal, the network consumes more signaling resources in this manner. In particular, for a configuration of the beacon signal, some parameters, for example, the beacon signal period, included in the configuration do not need to be configured to be different for different terminals.

Therefore, in this embodiment of this application, the beacon signal configuration information and the wake-up signal configuration information are configured in different configuration manners. To be specific, at least some information in the beacon signal configuration information and/or at least some information in the wake-up signal configuration information is configured by using cell common signaling, that is, cell-level signaling, or is specified in a specification. At least some other information in the beacon signal configuration information and/or at least some other information in the wake-up signal configuration information is configured by using UE specific signaling. In this way, when different terminals need to be configured with some different information, some different information can be configured for these terminals. However, when a plurality of terminals need to be configured with same information, configuration may be performed in a unified manner, to save signaling resources.

Optionally, the first beacon signal configuration information includes at least one of A-1 to A-8:
A-1: a beacon signal period;
A-2: a reference beacon signal period;
A-3: a start position of the beacon signal period;
A-4: an end position of the beacon signal period;
A-5: a start offset of beacon signal monitoring;
A-6: a beacon signal sequence; A-7: a beacon signal monitoring occasion; or
A-8: beacon signal monitoring duration.

A-1 indicates that the beacon signal period may be configured by using cell common signaling or specified in a specification. In this way, different beacon signal periods may be configured for different cells, cells in different SFNs, or cells in different RAN notification areas. Optionally, beacon signal periods applied by terminals in a cell, an SFN, or a same RAN notification area are the same.

The reference beacon signal period in A-2 may also be referred to as a default beacon signal period. The reference beacon signal period may be used for determining the wake-up signal monitoring offset information (where a specific determining method is described below).

Optionally, the reference beacon signal period is a minimum or maximum beacon signal period that can be configured by the network side device. If the network side device does not configure the reference beacon signal period, the reference beacon signal period is defined as a default value. When the reference beacon signal period is a default value (that is, a fixed value), it indicates that values of the reference beacon signal period are the same for terminals in all cells (for example, all cells in an SFN or a RAN notification area). In this way, when determining the wake-up signal monitoring offset information based on the reference beacon signal period, the terminal may not have inconsistent understanding. Optionally, the method further includes:

applying, by the terminal, the reference beacon signal period when the beacon signal period is not configured.

To be specific, when the beacon signal period in A-1 is not configured, the terminal uses the reference beacon signal period in A-2 as a beacon signal period.

It is to be noted herein that, that a parameter is not configured may be understood as that a parameter is lacked. Parts involved below are understood in a same manner, and details are not described again.

The start offset of beacon signal monitoring in A-5 is a time offset of a start position of the beacon signal relative to a reference location, where the reference location may be the start position of the beacon signal period, or may be a start position of the reference beacon signal period.

In an embodiment, a transmit end periodically sends a low power beacon signal. A start position of a 1^{st} beacon signal period is denoted as S, a period length is denoted as P, each period includes M low power beacon signals, a length of each beacon signal is denoted as L, and a time offset of a start position of a 1^{st} beacon signal in each period relative to the start position of the beacon signal period is denoted as ΔS. The time offset ΔS may be 0. As shown in FIG. 7, a start position of an n^{th} beacon signal period is denoted as (n−1)*P+S, and a start position of an mth beacon signal in the n^{th} beacon signal period is denoted as (n−1)*P+S++ (m−1)*L.

A receive end receives beacon signal configuration information, including a start position S, a time offset ΔS, a period length P, a quantity M of beacon signals in a period, and a beacon signal length L. The receive end receives high layer signaling through a main communication module to obtain configuration information, or receives configuration information through a low power module, or determines configuration information based on a system pre-configuration. The start position S of the beacon signal period may alternatively be determined without using a manner indicated by the configuration information. For example, when detecting the beacon signal for the first time, the receive end performs sequence detection on a preamble in the beacon signal through blind detection. After successfully detecting the preamble and identifying a beacon signal, the receive end obtains a sequence number of the beacon signal in one period and a sequence number of a beacon period, and then determines the start position S of the beacon signal period based on the time offset ΔS, the period length P, the quantity M of beacon signals in a period, and the beacon signal length L.

In another embodiment, the start offset of beacon signal monitoring is configured based on the reference beacon signal period and an offset, that is, an actual beacon signal period may be an integer multiple or a factor of the reference beacon signal period, and an actual start offset of beacon signal monitoring is determined based on a reference beacon signal start offset.

A-6 indicates that the beacon signal sequence may be configured by using cell common signaling or specified in a specification. In this way, different beacon signal sequences may be configured for different cells or cells in different SFNs. Optionally, beacon signal sequences applied by terminals in a cell or an SFN are the same.

Optionally, there is an association relationship between a beacon signal sequence and a cell identifier. For example, a beacon signal carries cell identifier information. Specifically, the information may be carried by using a beacon signal sequence or an information field of the beacon signal.

The beacon signal monitoring occasion in A-7 is a time domain location of beacon signal detection, and is in the beacon signal monitoring duration. For example, if two beacon signal monitoring occasions are provided in the beacon signal monitoring duration, the network side device may send a beacon signal at each of the two beacon signal monitoring occasions. In this case, the terminal has two opportunities of monitoring the beacon signal in monitoring duration of a beacon signal period.

The beacon signal monitoring duration in A-8 may also be referred to as a monitoring time window, and is duration for which the terminal needs to perform beacon signal monitoring in a beacon signal period. The terminal monitors a beacon signal only in monitoring duration of each beacon signal period, and does not monitor the beacon signal in other time.

Optionally, a start position of the beacon signal monitoring duration is the same as the start position of the beacon signal period.

The reference beacon signal start offset is a time offset of a start position for monitoring a beacon signal in the reference beacon signal period relative to the start position of the reference beacon signal period.

Optionally, the first wake-up signal configuration information includes at least one of B-1 to B-4:
B-1: a default wake-up signal period;
B-2: default wake-up signal monitoring duration;
B-3: a wake-up signal monitoring occasion; or B-4: a wake-up signal sequence.

An application scenario of the “default wake-up signal period” in B-1 may be described as follows:
applying, by the terminal, the default wake-up signal period when a wake-up signal period other than the default wake-up signal period is not configured;
when the second wake-up signal configuration information includes a wake-up signal period (that is, the wake-up signal period is configured by using UE specific signaling) and the first wake-up signal configuration information includes the default wake-up signal period (that is, the default wake-up signal period is configured by using cell common signaling or specified in a specification), applying, by the terminal, the wake-up signal period included in the second wake-up signal configuration information (namely, the wake-up signal period configured by using the UE specific signaling); or
continuously monitoring, by the terminal, the wake-up signal when a wake-up signal period is not configured or a configured wake-up signal period is a first preset value. “A wake-up signal period is not configured” means that the second wake-up signal configuration information does not include a wake-up signal period (that is, the wake-up signal period is not configured by using UE specific signaling), and the first wake-up signal configuration information does not include the default wake-up signal period (that is, the default wake-up signal period is not configured by using cell common signaling or specified in a specification). “A configured wake-up signal period is a first preset value” means that a wake-up signal period (namely, the wake-up signal period configured by using UE specific signaling) included in the second wake-up signal configuration information and the default wake-up signal period (namely, the default wake-up signal period configured by using cell common signaling or specified in a specification) included in the first wake-up signal configuration information are the first preset value.

B-2 indicates that the default wake-up signal monitoring duration may be configured by using cell common signaling or specified in a specification. To be specific, default wake-up signal monitoring duration of all terminals in a cell is the same. For example, the default wake-up signal monitoring duration may be 10 ms.

The wake-up signal monitoring duration may also be referred to as a monitoring time window, and is duration for which the terminal needs to perform wake-up signal monitoring in a wake-up signal period. The terminal monitors a wake-up signal in wake-up signal monitoring duration of each wake-up signal period, and does not monitor the wake-up signal in other time.

The wake-up signal monitoring occasion in B-3 is a time domain location of wake-up signal detection, and is in the wake-up signal monitoring duration. For example, if two wake-up signal monitoring occasions are provided in the wake-up signal monitoring duration, the network side device may send a wake-up signal at either of the two wake-up signal monitoring occasions. In this case, the terminal has two opportunities of monitoring the wake-up signal in monitoring duration of a wake-up signal period.

B-4 indicates that the wake-up signal sequence may be configured by using cell common signaling or specified in a specification. In this way, different wake-up signal sequences may be configured for different cells or cells in different SFNs. Optionally, wake-up signal sequences applied by terminals in a cell or all cells in an SFN are the same.

Optionally, there is an association relationship between a wake-up signal sequence and a cell identifier. For example, a wake-up signal carries cell identifier information. Specifically, the information may be carried by using a wake-up signal sequence or an information field of the wake-up signal.

Optionally, the wake-up signal sequence and a beacon signal sequence are a same sequence, or a beacon signal sequence and the wake-up signal sequence have a same component part.

Optionally, the second beacon signal configuration information includes at least one of the following:
a beacon signal sequence;
a beacon signal monitoring occasion; or
beacon signal monitoring duration.

In other words, the parameter included in the second beacon signal configuration information may be configured by using UE specific signaling. In this way, different second beacon signal configuration parameters and values may be configured for different terminals, so that particular configuration flexibility can be ensured. It is to be noted that, specific understanding of the beacon signal sequence, the beacon signal monitoring occasion, and the beacon signal monitoring duration is consistent with understanding of same parameters included in the first beacon signal configuration information. Details are not described herein again.

Optionally, the second wake-up signal configuration information includes at least one of C-1 to C-6:
C-1: a wake-up signal period;
C-2: wake-up signal monitoring duration;
C-3: wake-up signal monitoring offset information, where the wake-up signal monitoring offset information indicates information related to an offset of the wake-up signal period or the wake-up signal monitoring duration relative to a beacon signal period;
C-4: a wake-up signal monitoring offset list, where the monitoring offset list includes the wake-up signal monitoring offset information associated with different cells or different beacon signal periods;
C-5: a wake-up signal sequence; or
C-6: a wake-up signal monitoring occasion.
C-1 indicates that the wake-up signal period may be configured by using UE specific signaling, that is, wake-up signal periods of different terminals may be different.
C-2 indicates that the wake-up signal monitoring duration may be configured by using UE specific signaling, that is, wake-up signal monitoring duration of different terminals may be different.
C-3 indicates that the wake-up signal monitoring offset information may be configured by using UE specific signaling, that is, wake-up signal monitoring offset information of different terminals may be different. Such a configuration can alleviate, to some extent, a problem such as limited resource scheduling on a network side caused by many terminals performs wake-up signal monitoring at a same location, and a problem such as mutual interference between wake-up signals by a plurality of terminals, so that scheduling flexibility of a network can be implemented.

Optionally, the wake-up signal monitoring offset information includes at least one of the following:
a first time interval, where the first time interval is a time interval between a first location and a second location, the first location is a start position of the wake-up signal period or a start position of the wake-up signal monitoring duration, and the second location is a start position or an end position of a beacon signal period applied by the terminal;
a second time interval, where the second time interval is a time interval between the first location and a third location, and the third location is a start position or an end position of a reference beacon signal period; or
a first ratio, where the first ratio is a ratio of the first time interval to the beacon signal period applied by the terminal.

The first time interval is an offset of the start position of the wake-up signal period or the start position of the wake-up signal monitoring duration relative to the start position or end position of the beacon signal period applied by the terminal.

For example, in an embodiment, the network side device configures, by using UE specific signaling, the wake-up signal period (for example, 40 ms), the wake-up signal monitoring duration (for example, 10 ms), and the offset (namely, a first time interval, for example, 20 ms) of the start position of the wake-up signal period relative to the start position of the beacon signal period applied by the terminal. The configuration information is shown in FIG. 6. The terminal may periodically perform wake-up signal monitoring based on the foregoing configuration.

Optionally, if the first time interval is configured, but the first ratio is not configured, the terminal uses a same first time interval when different beacon signal periods are applied. For example, the first time interval is 10 ms when a beacon signal period of 100 ms and a beacon signal period of 200 ms are separately applied.

The cell involved in the wake-up signal monitoring offset list in C-4 may be a neighboring cell of the terminal.

The wake-up signal sequence in C-5 is used for receiving a wake-up signal, for example, used for functions such as synchronization, automatic gain control (Automatic Gain Control, AGC), and assisting in signal detection.

C-6 indicates that the wake-up signal monitoring occasion may be configured by using UE specific signaling, that is, wake-up signal monitoring occasions of different terminals may be different.

Optionally, a start position of the wake-up signal monitoring duration is the same as a start position of the wake-up signal period.

Optionally, the method further includes at least one of D-1 to D-5:
D-1: when the wake-up signal monitoring offset information includes the first time interval, determining, by the terminal, a monitoring location of the wake-up signal based on the beacon signal period applied by the terminal and the first time interval;
D-2: when the wake-up signal monitoring offset information includes the first time interval, calculating, by the terminal, a remainder of the first time interval modulo the beacon signal period applied by the terminal, to obtain a third time interval, and determining a monitoring location of the wake-up signal based on the beacon signal period applied by the terminal and the third time interval;
D-3: when the wake-up signal monitoring offset information includes the second time interval, determining, by the terminal, a monitoring location of the wake-up signal based on the reference beacon signal period and the second time interval;
D-4: when the wake-up signal monitoring offset information includes the second time interval, calculating, by the terminal, a product of a second ratio and the second time interval, to obtain a fourth time interval, and determining a monitoring location of the wake-up signal based on the reference beacon signal period and the fourth time interval, where the second ratio is a ratio of the beacon signal period applied by the terminal to the reference beacon signal period; or
D-5: when the wake-up signal monitoring offset information includes the first ratio, calculating, by the terminal, a product of the first ratio and the beacon signal period applied by the terminal, to obtain a fifth time interval, and determining a monitoring location of the wake-up signal based on the beacon signal period applied by the terminal and the fifth time interval, where

the monitoring location of the wake-up signal is the start position of the wake-up signal monitoring duration or the start position of the wake-up signal period.

D-1 indicates that the terminal may use a same first time interval in different beacon signal periods.

The third time interval in D-2=the first time interval modulo the beacon signal period applied by the terminal. In an embodiment, the first time interval is configured to be large, for example, 120 ms. In this case, when the terminal applies a beacon signal period of, for example, 100 ms, a remainder of the first time interval modulo the beacon signal period is calculated to obtain the third time interval, for example, 120 ms mod 100 ms=20 ms. In this way, the monitoring location of the wake-up signal is determined based on the third time interval and the beacon signal period applied by the terminal.

The second time interval in D-3 is an offset of the start position of the wake-up signal period or the start position of the wake-up signal monitoring duration relative to the start position or end position of the reference beacon signal period. In this way, the monitoring location of the wake-up signal can be determined based on the reference beacon signal period and the second time interval.

The fourth time interval in D-4=the beacon signal period applied by the terminal/the reference beacon signal period*the second time interval. It can be learned that, the terminal can calculate the beacon signal period applied by the terminal/the reference beacon signal period*the second time interval, to obtain a new second time interval (namely, the fourth time interval) matching the beacon signal period applied by the terminal. In this way, the monitoring location of the wake-up signal can be determined based on the fourth time interval and the reference beacon signal period.

The fifth time interval in D−5=the first ratio*the beacon signal period applied by the terminal. The first ratio is a ratio of the first time interval (that is, an offset of the start position of the wake-up signal period or the start position of the wake-up signal monitoring duration relative to the start position or end position of the beacon signal period applied by the terminal) to the beacon signal period applied by the terminal. Therefore, the beacon signal period applied by the terminal is multiplied by the first ratio to obtain the fifth time interval, so as to obtain a new first time interval matching the beacon signal period applied by the terminal. In this way, the monitoring location of the wake-up signal can be determined based on the fifth time interval and the beacon signal period applied by the terminal.

It can be learned that, the terminal may obtain a corresponding first time interval based on the first ratio when different beacon signal periods are applied.

Optionally, the method further includes:

when the second wake-up signal configuration information includes the wake-up signal monitoring offset list, obtaining, by the terminal based on the wake-up signal monitoring offset list, wake-up signal monitoring offset information associated with a target cell or wake-up signal monitoring offset information associated with a beacon signal period applied by the terminal, where the target cell is a cell indicated by a cell identifier carried in the beacon signal.

It can be learned that, when the wake-up signal monitoring offset list is configured, the terminal may search the list for wake-up signal monitoring offset information associated with the cell indicated by the cell identifier carried in the beacon signal monitored by the terminal, or search for wake-up signal monitoring offset information associated with the beacon signal period applied by the terminal, and further determine the monitoring location of the wake-up signal based on the found wake-up signal monitoring offset information. When the wake-up signal monitoring offset information includes different content, for a specific manner of determining the monitoring location of the wake-up signal, refer to D-1 to D-5 described above. Details are not described herein again.

Optionally, the method further includes at least one of E-1 to E-4:
E-1: determining, by the terminal, a beacon signal period or a reference beacon signal period as the wake-up signal period when the wake-up signal period is not configured;
E-2: determining, by the terminal, a beacon signal sequence as the wake-up signal sequence when the wake-up signal sequence is not configured;
E-3: determining, by the terminal, a beacon signal monitoring occasion as the wake-up signal monitoring occasion when the wake-up signal monitoring occasion is not configured; or
E-4: determining, by the terminal, beacon signal monitoring duration as the wake-up signal monitoring duration when the wake-up signal monitoring duration is not configured.

E-1 indicates that when the terminal does not receive any configuration information of the wake-up signal period, the terminal assumes that the wake-up signal period is equal to the beacon signal period or the reference beacon signal period.

E-2 indicates that when the terminal does not receive any configuration information of the wake-up signal sequence, the terminal assumes that the wake-up signal sequence is configured the same as the beacon signal sequence.

E-3 indicates that when the terminal does not receive any configuration information of the wake-up signal monitoring occasion, the terminal assumes that the wake-up signal monitoring occasion is configured the same as the beacon signal monitoring occasion.

E-4 indicates that when the terminal does not receive any configuration information of the wake-up signal monitoring duration, the terminal assumes that the wake-up signal monitoring duration is configured the same as the beacon signal monitoring duration.

According to a second aspect, FIG. 8 is a flowchart of a signal processing method according to an embodiment of this application. The method may include step 801 in the following:

Step 801: A network side device configures beacon signal configuration information and wake-up signal configuration information for a terminal in different configuration manners.

The network side device in step 801 may be one network side device, or may be a plurality of network side devices. In other words, the beacon signal configuration information and the wake-up signal configuration information may be configured by a network side device for the terminal in different manners, or the beacon signal configuration information and the wake-up signal configuration information may be configured by different network side devices for the terminal in different manners.

After obtaining the beacon signal configuration information and the wake-up signal configuration information configured by the network side device, the terminal may monitor a beacon signal and a wake-up signal based on the obtained beacon signal configuration information and the wake-up signal configuration information.

It can be learned that, in this embodiment of this application, the beacon signal configuration information and the wake-up signal configuration information are configured in different configuration manners. The beacon signal configuration information includes a plurality of pieces of different configuration information, and the wake-up signal configuration information includes a plurality of pieces of different configuration information. Different configuration information in the beacon signal configuration information and different configuration information in the wake-up signal configuration information may be flexibly combined, and obtained combinations may be configured in different configuration manners.

The beacon signal configuration information may include at least one of a beacon signal period, a reference beacon signal period, a start position of the beacon signal period, an end position of the beacon signal period, a start offset of beacon signal monitoring, a beacon signal sequence, a beacon signal monitoring occasion, or beacon signal monitoring duration.

In addition, the wake-up signal configuration information may include at least one of a wake-up signal period, wake-up signal monitoring duration, a wake-up signal sequence, a wake-up signal monitoring occasion, wake-up signal monitoring offset information, or a wake-up signal monitoring offset list.

It can be learned that, in this embodiment of this application, several of “the beacon signal period, the reference beacon signal period, the start position of the beacon signal period, the end position of the beacon signal period, the start offset of beacon signal monitoring, the beacon signal sequence, the beacon signal monitoring occasion, the beacon signal monitoring duration, the wake-up signal period, the wake-up signal monitoring duration, the wake-up signal sequence, the wake-up signal monitoring occasion, the wake-up signal monitoring offset information, and the wake-up signal monitoring offset list” may be flexibly combined, and obtained combinations may be configured in different configuration manners.

As can be learned from step 801, in the embodiments of this application, the beacon signal configuration information and the wake-up signal configuration information can be configured for the terminal in different configuration manners. In other words, the beacon signal configuration information and the wake-up signal configuration information are no longer configured in a single configuration manner. In this way, some information in the beacon signal configuration information and some information in the wake-up signal configuration information can be configured in different manners, so that flexibility of the beacon signal configuration information and wake-up signal configuration information is improved, and when different terminals need to be configured with some different information, some different information can be configured for different terminals. However, when a plurality of terminals need to be configured with same information, configuration may be performed in a unified manner, to save signaling resources and reduce a probability that the terminal has inconsistent understanding with a network side device in different configuration manners, so as to improve communication reliability.

Optionally, the configuring, by a network side device, beacon signal configuration information and wake-up signal configuration information for a terminal in different configuration manners includes:
sending, by the network side device, cell common signaling to the terminal, where the cell common signaling carries at least one of first beacon signal configuration information or first wake-up signal configuration information; and
sending, by the network side device, UE specific signaling to the terminal, where the UE specific signaling carries at least one of second beacon signal configuration information or second wake-up signal configuration information.

It can be learned that, in this embodiment of this application, the beacon signal configuration information and the wake-up signal configuration information are configured in different configuration manners. To be specific, at least some information in the beacon signal configuration information and/or at least some information in the wake-up signal configuration information is configured by using cell common signaling, that is, cell-level signaling, or is specified in a specification. At least some other information in the beacon signal configuration information and/or at least some other information in the wake-up signal configuration information is configured by using UE specific signaling. In this way, when different terminals need to be configured with some different information, some different information can be configured for these terminals. However, when a plurality of terminals need to be configured with same information, configuration may be performed in a unified manner, to save signaling resources.

Optionally, the first beacon signal configuration information includes at least one of A-1 to A-8:
A-1: a beacon signal period;
A-2: a reference beacon signal period;
A-3: a start position of the beacon signal period;
A-4: an end position of the beacon signal period;
A-5: a start offset of beacon signal monitoring;
A-6: a beacon signal sequence;
A-7: a beacon signal monitoring occasion; or
A-8: beacon signal monitoring duration.

For related descriptions about A-1 to A-8, refer to the foregoing descriptions. Details are not described herein again.

Optionally, a start position of the beacon signal monitoring duration is the same as the start position of the beacon signal period.

Optionally, the first wake-up signal configuration information includes at least one of B-1 to B-4:
B-1: a default wake-up signal period;
B-2: default wake-up signal monitoring duration;
B-3: a wake-up signal monitoring occasion; or
B-4: a wake-up signal sequence.

For related descriptions about B-1 to B-4, refer to the foregoing descriptions. Details are not described herein again.

Optionally, the wake-up signal sequence and a beacon signal sequence are a same sequence, or a beacon signal sequence and the wake-up signal sequence have a same component part.

Optionally, the second wake-up signal configuration information includes at least one of C-1 to C-6:
C-1: a wake-up signal period;
C-2: wake-up signal monitoring duration;
C-3: wake-up signal monitoring offset information, where the wake-up signal monitoring offset information indicates information related to an offset of the wake-up signal period or the wake-up signal monitoring duration relative to a beacon signal period;
C-4: a wake-up signal monitoring offset list, where the monitoring offset list includes the wake-up signal monitoring offset information associated with different cells or different beacon signal periods;
C-5: a wake-up signal sequence; or
C-6: a wake-up signal monitoring occasion.

For related descriptions about C-1 to C-6, refer to the foregoing descriptions. Details are not described herein again.

Optionally, a start position of the wake-up signal monitoring duration is the same as a start position of the wake-up signal period.

Optionally, the wake-up signal monitoring offset information includes at least one of the following:
a first time interval, where the first time interval is a time interval between a first location and a second location, the first location is a start position of the wake-up signal period or a start position of the wake-up signal monitoring duration, and the second location is a start position or an end position of a beacon signal period applied by the terminal;
a second time interval, where the second time interval is a time interval between the first location and a third location, and the third location is a start position or an end position of a reference beacon signal period; or
a first ratio, where the first ratio is a ratio of the first time interval to the beacon signal period applied by the terminal.

For related descriptions about the first time interval, the second time interval, and the first ratio, refer to the foregoing descriptions. Details are not described herein again.

Optionally, a beacon signal and/or a wake-up signal carries cell identifier information.

In conclusion, an implementation of the signal processing method in the embodiments of this application may be described as follows:

Different configuration manners may be further classified based on the beacon signal configuration information and the wake-up signal configuration information.

For example, the beacon signal period may be configured in a cell-level configuration manner (that is, configured by using cell common signaling); and the wake-up signal monitoring offset information may be configured in a terminal-level configuration manner (that is, configured by using UE specific signaling).

In the foregoing example, if the terminal is in an LP-WUS monitoring state (where in this case, main radio of the terminal is not enabled, which is equivalent to performing cell selection or reselection by using the beacon signal), when a current cell is handed over to another cell, a monitoring location of the wake-up signal (that is, the start position of the wake-up signal monitoring duration or the start position of the wake-up signal period) may be determined in one of Manners 1 to 5 in the following:

Manner 1: A reference beacon signal period (for example, as specified in a specification) is defined, and the wake-up signal monitoring offset information is information related to an offset of the wake-up signal period or the wake-up signal monitoring duration relative to the reference beacon signal period, for example, the wake-up signal monitoring offset information includes the second time interval, and the second time interval is an offset of the start position of the wake-up signal period or the start position of the wake-up signal monitoring duration relative to the start position or end position of the reference beacon signal period, so that the terminal determines the monitoring location of the wake-up signal based on the second time interval and the reference beacon signal period.

Manner 2: The wake-up signal monitoring offset information includes the first ratio, where the first ratio is a ratio of the first time interval to the beacon signal period applied by the terminal, and the first time interval is an offset of the start position of the wake-up signal period or the start position of the wake-up signal monitoring duration relative to the start position or end position of the beacon signal period applied by the terminal, so that the terminal calculates a product of the first ratio and the beacon signal period applied by the terminal, to obtain a fifth time interval, and determines the monitoring location of the wake-up signal based on the beacon signal period applied by the terminal and the fifth time interval.

In this case, different beacon signal periods each only need to be multiplied by the first ratio, to obtain the first time interval in each beacon signal period.

Manner 3: The first time interval is always fixed when different beacon signal periods are not considered, that is, an offset of the start position of the wake-up signal period or the start position of the wake-up signal monitoring duration relative to the start position or end position of the beacon signal period applied by the terminal is always fixed.

Manner 4: If different beacon signal periods are configured for different cells, when the terminal reselects a cell, a configuration of an original cell is still used for LP-WUS detection. That is, the network side device ensures that time domain locations of wake-up signals in different cells overlap.

Manner 5: The network side device indicates the wake-up signal monitoring offset list for the terminal by using UE specific signaling (for example, an RRC release message). The list includes wake-up signal monitoring offset information associated with different cells or different beacon signal periods, and the wake-up signal monitoring offset information may include at least one of the first time interval, the second time interval, or the first ratio described above.

After obtaining the cell ID information by using the beacon signal, the terminal uses wake-up signal monitoring offset information associated with the cell. In this way, the terminal may flexibly apply different wake-up signal monitoring offset information between different cells based on the wake-up signal monitoring offset list. Therefore, the network side device can configure different wake-up signal monitoring offset information on neighboring cells for the terminal, to ensure that time domain monitoring locations of the wake-up signal of terminals in different cells are staggered, so that interference between wake-up signals in different cells can be avoided to some extent.

In addition, in an embodiment, if the terminal does not use the beacon signal for cell selection and reselection, a problem that the terminal has inconsistent understanding with the network side device in different configuration manners does not occur.

The signal processing method provided in the embodiments of this application may be performed by a signal processing apparatus. In the embodiments of this application, the signal processing apparatus provided in the embodiments of this application is described by using an example in which the signal processing apparatus performs the signal processing method.

According to a third aspect, an embodiment of this application provides a signal processing apparatus, used in a terminal. As shown in FIG. 9, the signal processing apparatus 90 includes:

a first obtaining module 901, configured to obtain beacon signal configuration information and wake-up signal configuration information that are configured in different configuration manners; and

a monitoring module 902, configured to monitor a beacon signal and a wake-up signal based on the beacon signal configuration information and the wake-up signal configuration information.

Optionally, the first obtaining module 901 is specifically configured to:
obtain first information configured by using cell common signaling or specified in a specification, where the first information includes at least one of first beacon signal configuration information or first wake-up signal configuration information; and
obtain second information configured by using UE specific signaling, where the second information includes at least one of second beacon signal configuration information or second wake-up signal configuration information.

Optionally, the first beacon signal configuration information includes at least one of the following:
a beacon signal period;
a reference beacon signal period;
a start position of the beacon signal period;
an end position of the beacon signal period;
a start offset of beacon signal monitoring;
a beacon signal sequence;
a beacon signal monitoring occasion; or
beacon signal monitoring duration.

Optionally, the apparatus further includes:

a first processing module, configured to apply the reference beacon signal period when the beacon signal period is not configured.

Optionally, a start position of the beacon signal monitoring duration is the same as the start position of the beacon signal period.

Optionally, the first wake-up signal configuration information includes at least one of the following:
a default wake-up signal period;
default wake-up signal monitoring duration;
a wake-up signal monitoring occasion; or a wake-up signal sequence.

Optionally, the apparatus further includes at least one of the following modules:
a second processing module, configured to apply the default wake-up signal period when a wake-up signal period other than the default wake-up signal period is not configured;
a third processing module, configured to: when the second wake-up signal configuration information includes a wake-up signal period and the first wake-up signal configuration information includes the default wake-up signal period, apply the wake-up signal period included in the second wake-up signal configuration information; or
a fourth processing module, configured to continuously monitor the wake-up signal when a wake-up signal period is not configured or a configured wake-up signal period is a first preset value.

Optionally, the wake-up signal sequence and a beacon signal sequence are a same sequence, or a beacon signal sequence and the wake-up signal sequence have a same component part.

Optionally, the second wake-up signal configuration information includes at least one of the following:
a wake-up signal period;
wake-up signal monitoring duration;
wake-up signal monitoring offset information, where the wake-up signal monitoring offset information indicates information related to an offset of the wake-up signal period or the wake-up signal monitoring duration relative to a beacon signal period;
a wake-up signal monitoring offset list, where the monitoring offset list includes the wake-up signal monitoring offset information associated with different cells or different beacon signal periods;
a wake-up signal sequence; or a wake-up signal monitoring occasion.

Optionally, a start position of the wake-up signal monitoring duration is the same as a start position of the wake-up signal period.

Optionally, the wake-up signal monitoring offset information includes at least one of the following:
a first time interval, where the first time interval is a time interval between a first location and a second location, the first location is a start position of the wake-up signal period or a start position of the wake-up signal monitoring duration, and the second location is a start position or an end position of a beacon signal period applied by the terminal;
a second time interval, where the second time interval is a time interval between the first location and a third location, and the third location is a start position or an end position of a reference beacon signal period; or
a first ratio, where the first ratio is a ratio of the first time interval to the beacon signal period applied by the terminal.

Optionally, the apparatus further includes at least one of the following modules:
a first determining module, configured to: when the wake-up signal monitoring offset information includes the first time interval, determine a monitoring location of the wake-up signal based on the beacon signal period applied by the terminal and the first time interval;
a second determining module, configured to: when the wake-up signal monitoring offset information includes the first time interval, calculate a remainder of the first time interval modulo the beacon signal period applied by the terminal, to obtain a third time interval, and determining a monitoring location of the wake-up signal based on the beacon signal period applied by the terminal and the third time interval;
a third determining module, configured to: when the wake-up signal monitoring offset information includes the second time interval, determine a monitoring location of the wake-up signal based on the reference beacon signal period and the second time interval;
a fourth determining module, configured to: when the wake-up signal monitoring offset information includes the second time interval, calculate a product of a second ratio and the second time interval, to obtain a fourth time interval, and determine a monitoring location of the wake-up signal based on the reference beacon signal period and the fourth time interval, where the second ratio is a ratio of the beacon signal period applied by the terminal to the reference beacon signal period; or
a fifth determining module, configured to: when the wake-up signal monitoring offset information includes the first ratio, calculate a product of the first ratio and the beacon signal period applied by the terminal, to obtain a fifth time interval, and determine a monitoring location of the wake-up signal based on the beacon signal period applied by the terminal and the fifth time interval, where

the monitoring location of the wake-up signal is the start position of the wake-up signal monitoring duration or the start position of the wake-up signal period.

Optionally, the apparatus further includes:

a second obtaining module, configured to: when the second wake-up signal configuration information includes the wake-up signal monitoring offset list, obtain, based on the wake-up signal monitoring offset list, wake-up signal monitoring offset information associated with a target cell or wake-up signal monitoring offset information associated with a beacon signal period applied by the terminal, where the target cell is a cell indicated by a cell identifier carried in the beacon signal.

Optionally, the apparatus further includes at least one of the following modules:
a fifth processing module, configured to determine a beacon signal period or a reference beacon signal period as the wake-up signal period when the wake-up signal period is not configured;
a sixth processing module, configured to determine a beacon signal sequence as the wake-up signal sequence when the wake-up signal sequence is not configured;
a seventh processing module, configured to determine a beacon signal monitoring occasion as the wake-up signal monitoring occasion when the wake-up signal monitoring occasion is not configured; or
an eighth processing module, configured to determine beacon signal monitoring duration as the wake-up signal monitoring duration when the wake-up signal monitoring duration is not configured.

Optionally, the beacon signal and/or the wake-up signal carries cell identifier information.

The signal processing apparatus in this embodiment of this application may be an electronic device, for example, an electronic device with an operating system, or may be a component in the electronic device, for example, an integrated circuit or a chip. The electronic device may be a terminal. For example, the terminal may include but is not limited to the foregoing terminal 11. This is not specifically limited in the embodiments of this application.

The signal processing apparatus provided in the embodiments of this application can implement the processes implemented in the method embodiment of FIG. 5 and achieve the same technical effect. To avoid repetition, details are not described herein again.

According to a fourth aspect, an embodiment of this application provides a signal processing apparatus, used in a network side device. As shown in FIG. 10, the signal processing apparatus 100 includes:

a configuration module 1001, configured to configure beacon signal configuration information and wake-up signal configuration information for a terminal in different configuration manners.

Optionally, the configuration module 1001 is specifically configured to:
send cell common signaling to the terminal, where the cell common signaling carries at least one of first beacon signal configuration information or first wake-up signal configuration information; and
send UE specific signaling to the terminal, where the UE specific signaling carries at least one of second beacon signal configuration information or second wake-up signal configuration information.

Optionally, the first beacon signal configuration information includes at least one of the following:
a beacon signal period;
a reference beacon signal period;
a start position of the beacon signal period;
an end position of the beacon signal period;
a start offset of beacon signal monitoring;
a beacon signal sequence;
a beacon signal monitoring occasion; or beacon signal monitoring duration.

Optionally, a start position of the beacon signal monitoring duration is the same as the start position of the beacon signal period.

Optionally, the first wake-up signal configuration information includes at least one of the following:
a default wake-up signal period;
default wake-up signal monitoring duration;
a wake-up signal monitoring occasion; or a wake-up signal sequence.

Optionally, the wake-up signal sequence and a beacon signal sequence are a same sequence, or a beacon signal sequence and the wake-up signal sequence have a same component part.

Optionally, the second wake-up signal configuration information includes at least one of the following:
a wake-up signal period;
wake-up signal monitoring duration;
wake-up signal monitoring offset information, where the wake-up signal monitoring offset information indicates information related to an offset of the wake-up signal period or the wake-up signal monitoring duration relative to a beacon signal period;
a wake-up signal monitoring offset list, where the monitoring offset list includes the wake-up signal monitoring offset information associated with different cells or different beacon signal periods;
a wake-up signal sequence; or a wake-up signal monitoring occasion.

Optionally, a start position of the wake-up signal monitoring duration is the same as a start position of the wake-up signal period.

Optionally, the wake-up signal monitoring offset information includes at least one of the following:
a first time interval, where the first time interval is a time interval between a first location and a second location, the first location is a start position of the wake-up signal period or a start position of the wake-up signal monitoring duration, and the second location is a start position or an end position of a beacon signal period applied by the terminal;
a second time interval, where the second time interval is a time interval between the first location and a third location, and the third location is a start position or an end position of a reference beacon signal period; or
a first ratio, where the first ratio is a ratio of the first time interval to the beacon signal period applied by the terminal.

Optionally, a beacon signal and/or a wake-up signal carries cell identifier information.

The signal processing apparatus in this embodiment of this application may be an electronic device, for example, an electronic device with an operating system, or may be a component in the electronic device, for example, an integrated circuit or a chip. The electronic device may be a network side device. For example, the network side device may include, but is not limited to, the type of the network side device 12 listed above. This is not specifically limited in the embodiments of this application.

The signal processing apparatus provided in the embodiments of this application can implement the processes implemented in the method embodiment of FIG. 8 and achieve the same technical effect. To avoid repetition, details are not described herein again.

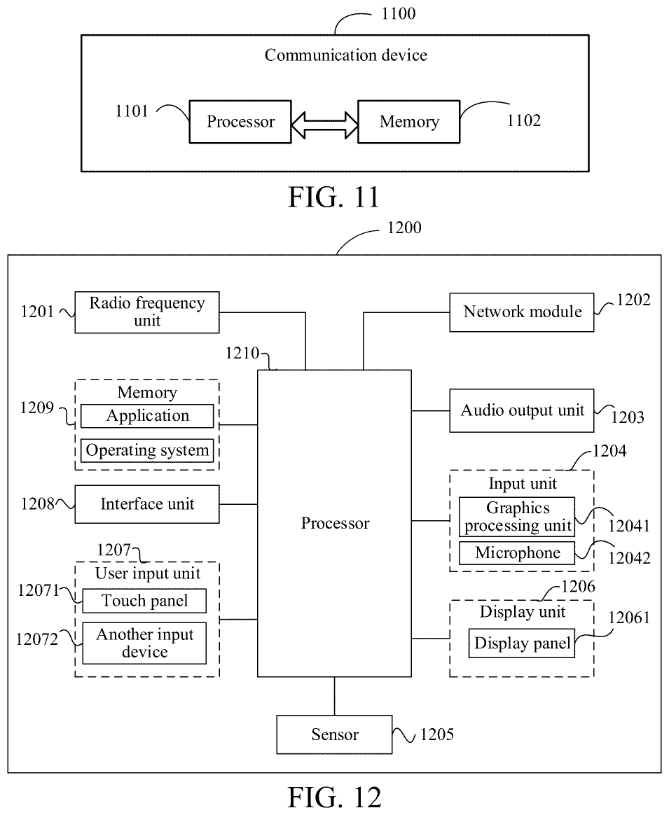

Optionally, as shown in FIG. 11, an embodiment of this application further provides a communication device 1100, including a processor 1101 and a memory 1102. The memory 1102 stores a program or instructions runnable on the processor 1101. For example, when the communication device 1100 is a terminal, the program or instructions are executed by the processor 1101 to implement the steps of the embodiments of the signal processing method according to the first aspect, and can achieve the same technical effects. When the communication device 1100 is a network side device, the program or instructions are executed by the processor 1101 to implement the steps of the embodiments of the signal processing method according to the second aspect, and can achieve the same technical effects. To avoid repetition, details are not described herein again.

An embodiment of this application further provides a terminal. FIG. 12 is a schematic diagram of a hardware structure of a terminal implementing an embodiment of this application.

The terminal 1200 includes, but is not limited to, at least some components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art may understand that the terminal 1200 may further include a power supply (such as a battery) that supplies power to components. The power supply may be logically connected to the processor 1210 through a power management system, thereby implementing functions such as management of charging, discharging, and power consumption through the power management system. A terminal structure shown in FIG. 12 does not constitute a limitation to the terminal. The terminal may include more or fewer components than those shown in the figure, or combine some components, or have different component arrangements. Details are not described herein again.

It should be noted that, in this embodiment of this application, the input unit 1204 may include a graphics processing unit (Graphics Processing Unit, GPU) 12041 and a microphone 12042. The graphics processing unit 12041 processes image data of a static picture or a video obtained by an image capturing apparatus (for example, a camera) in a video capturing mode or an image capturing mode. The display unit 1206 may include a display panel 12061. The display panel 12061 may be configured in a form such as a liquid crystal display or an organic light-emitting diode. The user input unit 1207 includes at least one of a touch panel 12071 or another input device 12072. The touch panel 12 071 is also referred to as a touchscreen. The touch panel 12071 may include a touch detection apparatus and a touch controller. The another input device 12072 may include but is not limited to a physical keyboard, a function button (such as a volume control button or a power button), a trackball, a mouse, and a joystick. Details are not described herein again.

In this embodiment of this application, the radio frequency unit 1201 receives downlink data from a network side device, and then may transmit the data to the processor 1210 for processing. In addition, the radio frequency unit 1201 may send uplink data to the network side device. Generally, the radio frequency unit 1201 includes but is not limited to an antenna, an amplifier, a transceiver, a coupler, a low noise amplifier, a duplexer, and the like.

The memory 1209 may be configured to store a software program and various types of data. The memory 1209 may mainly include a first storage area that stores a program storage or instructions and a second storage area that stores data. The first storage area may store an operating system, an application or instructions required by at least one function (for example, a sound playback function and an image playback function), or the like. In addition, the memory 1209 may include a volatile memory or a non-volatile memory, or the memory 1209 may include both a volatile memory and a non-volatile memory. The non-volatile memory may be a read-only memory (ROM), a programmable ROM (PROM), an erasable programmable read-only memory (erasable PROM, EPROM), an electrically EPROM (EEPROM), or a flash memory. The volatile memory may be a random access memory (RAM), a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), and a direct rambus RAM (DRRAM). The memory 1209 in this embodiment of this application includes but is not limited to the above and any other suitable types of memories.

The processor 1210 may include one or more processing units. Optionally, the processor 1210 integrates an application processor and a modem processor. The application processor mainly processes operations involving an operating system, a user interface, an application, or the like. The modem processor mainly processes a wireless communication signal, for example, a baseband processor. It may be understood that, the foregoing modulation and demodulation processor may alternatively not be integrated into the processor 1210.

The radio frequency unit 1201 is configured to obtain beacon signal configuration information and wake-up signal configuration information that are configured in different configuration manners.

The processor 1210 is configured to monitor a beacon signal and a wake-up signal based on the beacon signal configuration information and the wake-up signal configuration information.

Optionally, the radio frequency unit 1201 obtains the beacon signal configuration information and the wake-up signal configuration information that are configured in different configuration manners, and is specifically configured to:
obtain first information configured by using cell common signaling or specified in a specification, where the first information includes at least one of first beacon signal configuration information or first wake-up signal configuration information; and
obtain second information configured by using UE specific signaling, where the second information includes at least one of second beacon signal configuration information or second wake-up signal configuration information.

Optionally, the first beacon signal configuration information includes at least one of the following:
a beacon signal period;
a reference beacon signal period;
a start position of the beacon signal period;
an end position of the beacon signal period;
a start offset of beacon signal monitoring;
a beacon signal sequence;
a beacon signal monitoring occasion; or
beacon signal monitoring duration.

Optionally, the processor 1210 is further configured to:

apply the reference beacon signal period when the beacon signal period is not configured.

Optionally, a start position of the beacon signal monitoring duration is the same as the start position of the beacon signal period.

Optionally, the first wake-up signal configuration information includes at least one of the following:
a default wake-up signal period;
default wake-up signal monitoring duration;
a wake-up signal monitoring occasion; or a wake-up signal sequence.

Optionally, the processor 1210 is further configured to perform at least one of the following:
applying the default wake-up signal period when a wake-up signal period other than the default wake-up signal period is not configured;
when the second wake-up signal configuration information includes a wake-up signal period and the first wake-up signal configuration information includes the default wake-up signal period, applying the wake-up signal period included in the second wake-up signal configuration information; or
continuously monitoring the wake-up signal when a wake-up signal period is not configured or a configured wake-up signal period is a first preset value.

Optionally, the wake-up signal sequence and a beacon signal sequence are a same sequence, or a beacon signal sequence and the wake-up signal sequence have a same component part.

Optionally, the second wake-up signal configuration information includes at least one of the following:
a wake-up signal period;
wake-up signal monitoring duration;
wake-up signal monitoring offset information, where the wake-up signal monitoring offset information indicates information related to an offset of the wake-up signal period or the wake-up signal monitoring duration relative to a beacon signal period;
a wake-up signal monitoring offset list, where the monitoring offset list includes the wake-up signal monitoring offset information associated with different cells or different beacon signal periods;
a wake-up signal sequence; or
a wake-up signal monitoring occasion.

Optionally, a start position of the wake-up signal monitoring duration is the same as a start position of the wake-up signal period.

Optionally, the wake-up signal monitoring offset information includes at least one of the following:
a first time interval, where the first time interval is a time interval between a first location and a second location, the first location is a start position of the wake-up signal period or a start position of the wake-up signal monitoring duration, and the second location is a start position or an end position of a beacon signal period applied by the terminal;
a second time interval, where the second time interval is a time interval between the first location and a third location, and the third location is a start position or an end position of a reference beacon signal period; or
a first ratio, where the first ratio is a ratio of the first time interval to the beacon signal period applied by the terminal.

Optionally, the processor 1210 is further configured to perform at least one of the following:
when the wake-up signal monitoring offset information includes the first time interval, determining a monitoring location of the wake-up signal based on the beacon signal period applied by the terminal and the first time interval;
when the wake-up signal monitoring offset information includes the first time interval, calculating a remainder of the first time interval modulo the beacon signal period applied by the terminal, to obtain a third time interval, and determining a monitoring location of the wake-up signal based on the beacon signal period applied by the terminal and the third time interval;
when the wake-up signal monitoring offset information includes the second time interval, determining a monitoring location of the wake-up signal based on the reference beacon signal period and the second time interval;
when the wake-up signal monitoring offset information includes the second time interval, calculating a product of a second ratio and the second time interval, to obtain a fourth time interval, and determining a monitoring location of the wake-up signal based on the reference beacon signal period and the fourth time interval, where the second ratio is a ratio of the beacon signal period applied by the terminal to the reference beacon signal period; or

when the wake-up signal monitoring offset information includes the first ratio, calculating a product of the first ratio and the beacon signal period applied by the terminal, to obtain a fifth time interval, and determining a monitoring location of the wake-up signal based on the beacon signal period applied by the terminal and the fifth time interval, where

the monitoring location of the wake-up signal is the start position of the wake-up signal monitoring duration or the start position of the wake-up signal period.

Optionally, the processor 1210 is further configured to:
when the second wake-up signal configuration information includes the wake-up signal monitoring offset list, obtain, based on the wake-up signal monitoring offset list, wake-up signal monitoring offset information associated with a target cell or wake-up signal monitoring offset information associated with a beacon signal period applied by the terminal, where the target cell is a cell indicated by a cell identifier carried in the beacon signal.

Optionally, the processor 1210 is further configured to perform at least one of the following:
determining a beacon signal period or a reference beacon signal period as the wake-up signal period when the wake-up signal period is not configured;
determining a beacon signal sequence as the wake-up signal sequence when the wake-up signal sequence is not configured;
determining a beacon signal monitoring occasion as the wake-up signal monitoring occasion when the wake-up signal monitoring occasion is not configured; or
determining beacon signal monitoring duration as the wake-up signal monitoring duration when the wake-up signal monitoring duration is not configured.

Optionally, the beacon signal and/or the wake-up signal carries cell identifier information.

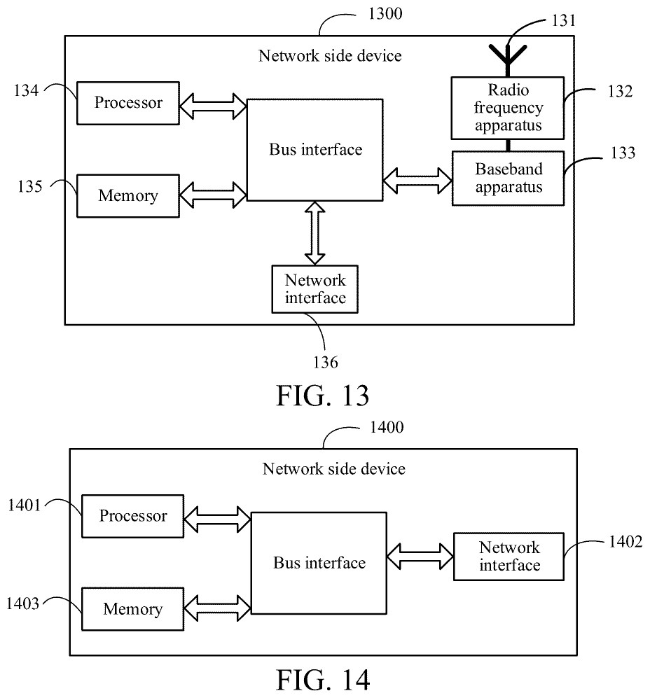

An embodiment of this application further provides a network side device. As shown in FIG. 13, the network side device 1300 includes an antenna 131, a radio frequency apparatus 132, a baseband apparatus 133, a processor 134, and a memory 135. The antenna 131 is connected to the radio frequency apparatus 132. In an uplink direction, the radio frequency apparatus 132 receives information by using the antenna 131, and sends the received information to the baseband apparatus 133 for processing. In a downlink direction, the baseband apparatus 133 processes to-be-sent information, and sends the processed to-be-sent information to the radio frequency apparatus 132. The radio frequency apparatus 132 processes the received information, and then sends the processed information through the antenna 131.

In the foregoing embodiments, the method performed by the network side device may be implemented in the baseband apparatus 133. The baseband apparatus 133 includes a baseband processor.

The baseband apparatus 133 may include, for example, at least one baseband plate. A plurality of chips are arranged on the baseband plate. As shown in FIG. 13, one of the plurality of chips is, for example, the baseband processor, and is connected to the memory 135 through a bus interface, to invoke a program in the memory 135 to perform operations performed by the network side device in the foregoing method embodiment.

The network side device may further include a network interface 136. The interface is, for example, a common public radio interface (common public radio interface, CPRI).

Specifically, the network side device 1300 in this embodiment of this application further includes: instructions or a program stored in the memory 135 and executable on the processor 134, and the processor 134 invokes the instructions or program in the memory 135 to perform the method shown in FIG. 8, and can achieve the same technical effect. To avoid repetition, details are not described herein again.

An embodiment of this application further provides a network side device. As shown in FIG. 14, the network side device 1400 includes a processor 1401, a network interface 1402, and a memory 1403. The network interface 1402 is, for example, a common public radio interface (common public radio interface, CPRI).

Specifically, the network side device 1400 in this embodiment of this application further includes: instructions or a program stored in the memory 1403 and executable on the processor 1401, and the processor 1401 invokes the instructions or program in the memory 1403 to perform the method shown in FIG. 8, and can achieve the same technical effect. To avoid repetition, details are not described herein again.

Embodiments of this application further provide a readable storage medium. The readable storage medium stores a program or instructions. The program or instructions, when executed by a processor, implement various processes of the embodiments of the signal processing method according to the first aspect or the second aspect, and can achieve the same technical effects. To avoid repetition, details are not described herein again.

The processor is a processor in the terminal in the foregoing embodiments. The readable storage medium includes a computer-readable storage medium, for example, a read-only memory ROM, a random access memory RAM, a magnetic disk, an optical disk, or the like.

An embodiment of this application further provides a chip, including a processor and a communication interface coupled to each other, the processor being configured to run a program or instructions to implement the processes of the embodiments of the signal processing method according to the first aspect or the second aspect, and can achieve the same technical effects. To avoid repetition, details are not described herein again.

It may be understood that, the chip mentioned in this embodiment of this application may also be referred to as a system-level chip, a system chip, a chip system, a system on chip, or the like.

Embodiments of this application further provide a computer program/program product. The computer program/program product is stored in a storage medium. The computer program/program product, when executed by at least one processor, implements various processes of the embodiments of the signal processing method according to the first aspect or the second aspect, and can achieve the same technical effects. To avoid repetition, details are not described herein again.

An embodiment of this application further provides a signal processing system, including a terminal and a network side device, where the terminal may be configured to perform the steps of the signal processing method according to the first aspect, and the network side device may be configured to perform the steps of the signal processing method according to the second aspect.

It is to be noted that, the term such as “include”, “comprise”, or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Unless otherwise specified, elements defined by the sentence “including one” does not exclude that there are still other same elements in the processes, methods, objects, or apparatuses. In addition, it is to be noted that, the scope of the method and the apparatus in the implementations of this application is not limited to executing functions in an order shown or discussed, and may also include executing the functions in a substantially simultaneous manner or in a reverse order according to involved functions. For example, the described method may be performed in an order different from that described order, and various steps may also be added, omitted, or combined. In addition, features described with reference to some examples may also be combined in other examples.

According to the descriptions of the foregoing implementations, a person skilled in the art may clearly understand that the method according to the foregoing embodiments may be implemented by means of software and a necessary general hardware platform, and certainly, may alternatively be implemented by hardware, but in many cases, the former manner is a better implementation. Based on such an understanding, the technical solutions of this application essentially or the part contributing to the related art may be implemented in the form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings. However, this application is not limited to the foregoing specific implementations. The foregoing specific implementations are merely illustrative rather than limitative. A person of ordinary skill in the art may derive various forms from this application without departing from the spirit of this application and the scope claimed by the claims, which are all under the protection of this application.

What is claimed is:

1. A signal processing method, comprising:
obtaining, by a terminal, beacon signal configuration information and wake-up signal configuration information that are configured in different configuration manners; and
monitoring, by the terminal, a beacon signal and a wake-up signal based on the beacon signal configuration information and the wake-up signal configuration information.

2. The method according to claim 1, wherein the obtaining, by a terminal, beacon signal configuration information and wake-up signal configuration information that are configured in different configuration manners comprises:
obtaining, by the terminal, first information configured by using cell common signaling or specified in a specification, wherein the first information comprises at least one of first beacon signal configuration information or first wake-up signal configuration information; and
obtaining, by the terminal, second information configured by using UE specific signaling, wherein the second information comprises at least one of second beacon signal configuration information or second wake-up signal configuration information.

3. The method according to claim 2, wherein the first beacon signal configuration information comprises at least one of the following:
a beacon signal period;
a reference beacon signal period;
a start position of the beacon signal period;
an end position of the beacon signal period;
a start offset of beacon signal monitoring;
a beacon signal sequence;
a beacon signal monitoring occasion; or
beacon signal monitoring duration.

4. The method according to claim 3, wherein the method further comprises:
applying, by the terminal, the reference beacon signal period when the beacon signal period is not configured; or
wherein a start position of the beacon signal monitoring duration is the same as the start position of the beacon signal period.

5. The method according to claim 2, wherein the first wake-up signal configuration information comprises at least one of the following:
a default wake-up signal period;
default wake-up signal monitoring duration;
a wake-up signal monitoring occasion; or
a wake-up signal sequence.

6. The method according to claim 5, wherein the method further comprises at least one of the following:
applying, by the terminal, the default wake-up signal period when a wake-up signal period other than the default wake-up signal period is not configured;
when the second wake-up signal configuration information comprises a wake-up signal period and the first wake-up signal configuration information comprises the default wake-up signal period, applying, by the terminal, the wake-up signal period comprised in the second wake-up signal configuration information; or
continuously monitoring, by the terminal, the wake-up signal when a wake-up signal period is not configured or a configured wake-up signal period is a first preset value, or wherein the wake-up signal sequence and a beacon signal sequence are a same sequence, or a beacon signal sequence and the wake-up signal sequence have a same component part.

7. The method according to claim 2, wherein the second wake-up signal configuration information comprises at least one of the following:
a wake-up signal period;
wake-up signal monitoring duration;
wake-up signal monitoring offset information, wherein the wake-up signal monitoring offset information indicates information related to an offset of the wake-up signal period or the wake-up signal monitoring duration relative to a beacon signal period;
a wake-up signal monitoring offset list, wherein the monitoring offset list comprises the wake-up signal monitoring offset information associated with different cells or different beacon signal periods;
a wake-up signal sequence; or
a wake-up signal monitoring occasion.

8. The method according to claim 7, wherein a start position of the wake-up signal monitoring duration is the same as a start position of the wake-up signal period, or wherein the wake-up signal monitoring offset information comprises at least one of the following:
a first time interval, wherein the first time interval is a time interval between a first location and a second location, the first location is a start position of the wake-up signal period or a start position of the wake-up signal monitoring duration, and the second location is a start position or an end position of a beacon signal period applied by the terminal;
a second time interval, wherein the second time interval is a time interval between the first location and a third location, and the third location is a start position or an end position of a reference beacon signal period; or
a first ratio, wherein the first ratio is a ratio of the first time interval to the beacon signal period applied by the terminal.

9. The method according to claim 7, wherein the method further comprises:
when the second wake-up signal configuration information comprises the wake-up signal monitoring offset list, obtaining, by the terminal based on the wake-up signal monitoring offset list, wake-up signal monitoring offset information associated with a target cell or wake-up signal monitoring offset information associated with a beacon signal period applied by the terminal, wherein the target cell is a cell indicated by a cell identifier carried in the beacon signal, or
wherein the method further comprises at least one of the following:
determining, by the terminal, a beacon signal period or a reference beacon signal period as the wake-up signal period when the wake-up signal period is not configured;
determining, by the terminal, a beacon signal sequence as the wake-up signal sequence when the wake-up signal sequence is not configured;
determining, by the terminal, a beacon signal monitoring occasion as the wake-up signal monitoring occasion when the wake-up signal monitoring occasion is not configured; or
determining, by the terminal, beacon signal monitoring duration as the wake-up signal monitoring duration when the wake-up signal monitoring duration is not configured.

10. The method according to claim 1, wherein the beacon signal and/or the wake-up signal carries cell identifier information.

11. A signal processing method, comprising:
configuring, by a network side device, beacon signal configuration information and wake-up signal configuration information for a terminal in different configuration manners.

12. The method according to claim 11, wherein the configuring, by a network side device, beacon signal configuration information and wake-up signal configuration information for a terminal in different configuration manners comprises:
sending, by the network side device, cell common signaling to the terminal, wherein the cell common signaling carries at least one of first beacon signal configuration information or first wake-up signal configuration information; and
sending, by the network side device, UE specific signaling to the terminal, wherein the UE specific signaling carries at least one of second beacon signal configuration information or second wake-up signal configuration information.

13. The method according to claim 12, wherein the first beacon signal configuration information comprises at least one of the following:
a beacon signal period;
a reference beacon signal period;
a start position of the beacon signal period;
an end position of the beacon signal period;
a start offset of beacon signal monitoring;
a beacon signal sequence;
a beacon signal monitoring occasion; or
beacon signal monitoring duration.

14. The method according to claim 13, wherein a start position of the beacon signal monitoring duration is the same as the start position of the beacon signal period.

15. The method according to claim 12, wherein the first wake-up signal configuration information comprises at least one of the following:
a default wake-up signal period;
default wake-up signal monitoring duration;
a wake-up signal monitoring occasion; or
a wake-up signal sequence.

16. The method according to claim 15, wherein the wake-up signal sequence and a beacon signal sequence are a same sequence, or a beacon signal sequence and the wake-up signal sequence have a same component part.

17. The method according to claim 12, wherein the second wake-up signal configuration information comprises at least one of the following:
a wake-up signal period;
wake-up signal monitoring duration;
wake-up signal monitoring offset information, wherein the wake-up signal monitoring offset information indicates information related to an offset of the wake-up signal period or the wake-up signal monitoring duration relative to a beacon signal period;
a wake-up signal monitoring offset list, wherein the monitoring offset list comprises the wake-up signal monitoring offset information associated with different cells or different beacon signal periods;
a wake-up signal sequence; or
a wake-up signal monitoring occasion.

18. The method according to claim 17, wherein a start position of the wake-up signal monitoring duration is the same as a start position of the wake-up signal period, or wherein the wake-up signal monitoring offset information comprises at least one of the following:
a first time interval, wherein the first time interval is a time interval between a first location and a second location, the first location is a start position of the wake-up signal period or a start position of the wake-up signal monitoring duration, and the second location is a start position or an end position of a beacon signal period applied by the terminal;
a second time interval, wherein the second time interval is a time interval between the first location and to a third location, and the third location is a start position or an end position of a reference beacon signal period; or
a first ratio, wherein the first ratio is a ratio of the first time interval to the beacon signal period applied by the terminal.

19. A terminal, comprising a processor and a memory, wherein the memory stores a program or instructions executable on the processor, and the program or the instructions, when executed by the processor, implement a signal processing method, wherein the signal processing method comprises:
obtaining, by the terminal, beacon signal configuration information and wake-up signal configuration information that are configured in different configuration manners; and
monitoring, by the terminal, a beacon signal and a wake-up signal based on the beacon signal configuration information and the wake-up signal configuration information.

20. A network side device, comprising a processor and a memory, wherein the memory stores a program or instructions executable on the processor, and the program or the instructions, when executed by the processor, implement the steps of the signal processing method according to claim 11.
